(19) United States
(12) Patent Application Publication
(10) Pub. No.: US 2008/0183712 A1
(43) Pub. Date: Jul. 31, 2008

(54) Capacity on Demand Computer Resources

(76) Inventors: William J. Westerinen, Issaquah, WA (US); Jeffrey Alan Herold, Bellevue, WA (US); Thomas G. Phillips, Bellevue, WA (US); Martin H. Hall, Sammamish, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(21) Appl. No.: 11/668,444

(22) Filed: Jan. 29, 2007

(51) Int. Cl. G06F 17/30

(52) U.S. Cl. 707/9

(57) ABSTRACT

A security module manages authorization of additional computing resources, either additional processing power in a server, or additional servers in a server enclosure responsive to an authorized message. The authorized message may be generated at a management node and may include a provisioning license for use by the security module to set a duration for use of the additional computing resources. A baseboard management controller may be house the security module or each controllable resource may house an associated security module. The baseboard management controller may store the authorized message when the security module is not active and forward the message after the security module has been activated.

### BACKGROUND

Many computer applications, particularly web-based applications, may have a wide variation between low and peak resource utilization. For example, an on-line voting and statistics application, may be virtually dormant for long periods of time while supporting low-level surveys, etc. However, when a peak load arises, for example, professional athlete all-star voting, the peak resource demands may be hundreds or thousands times above the normal level.

Several mechanisms have been used to address the problem of occasional increased demand. “Scale up” is a term that refers to adding computing capability to an existing resource, for example, adding a second processor, more memory, increased disk space, or a combination of all, to allow the existing resource to handle an increased load. “Scale out” refers to adding additional resources, such as adding more servers to a server farm, to spread a computational load among more systems. When the peak demand period is over, the added capacity may be reduced, presumably lowering the cost of operation of the product or service. Each requires different management techniques to spread the load and recover when the additional capacity is removed.

Both scale-up and scale-out techniques may involve temporarily adding resources to support an increased computation need. The added resources may be owned by an application/service provider or by a hosting service. In either case, adding the resources temporarily may reduce the cost to the application/service provider either in rental fees or operating cost (electricity, management, maintenance). However, it may be difficult to have confidence that the added resources are only used when authorized, especially when a party responsible for the added resources does not have physical access to a facility housing the added resources.

### SUMMARY

Scale up and scale out capacity adjustments may be made by a provisioning server in communication with specially equipped blade enclosure with one or more blade servers or a similar server architecture. The blade enclosure may incorporate a baseboard management controller (BMC) that can accept messages from the provisioning server to start or stop particular servers, or start servers for a predetermined processing duration or volume. Provisioning messages from the provisioning server may be accepted and at the BMC or may be passed from the BMC to the individual blade servers. Processing the provisioning messages my be performed by a security module capable of both cryptographic verification of the provisioning message and enforcing terms of use specified in the provisioning message. The security module may have a timer, cryptographic capability, and an server, or both. The security module may have a timer, cryptographic capability, and an ability to securely send a message to a controller responsible for starting and stopping processing assets. In one embodiment, a blade enclosure may provide power, cooling, and network interface to a number of blade servers. A baseboard management controller may be part of the blade enclosure and support execution of administration and maintenance functions similar to an administrator at a console of a traditional server. The baseboard management controller (BMC) may start and stop individual blade servers responsive to a command, but should communication with the BMC be interrupted, or experience another failure, operation of temporarily-authorized servers may continue after a contractual period has expired. The security module may be used to activate one or more of the blade servers and begin a self-timed expiration period that will automatically deactivate them at the designated time, even if external supervisory contact with the BMC is not available.

Several configurations of server, BMC, and security module are possible. The security module may be incorporated in the BMC, the security module and BMC may be separate, or the BMC and the security module may both be present on each server. In the latter configuration, the BMC may remain active when the server and security module are powered off. In that case, the BMC may store messages for the security module until the security module can be activated. An additional security component, or secure switch, may be added to the server and have the ability to disable either a resource (scale up), such as an additional processor or the entire server (scale out). The secure switch may be directly controlled by the security module or may accept messages via the BMC.

### BRIEF DESCRIPTION OF THE DRAWINGS

FIG. 1 is a block diagram of system supporting capacity-on-demand resource allocation;

FIG. 2 is a block diagram of another configuration of a system supporting capacity-on-demand resource allocation;

FIG. 3 is block diagram of yet another configuration of a system supporting capacity-on-demand resource allocation;

FIG. 4 is a block diagram of still another configuration of a system supporting capacity-on-demand resource allocation;

FIG. 5 is a block diagram of an exemplary server suitable for use in a system of FIGS. 1-4;

FIG. 6 is a block diagram of an exemplary baseboard management controller for use in a system of FIGS. 1-4;

FIG. 7 is a simplified and representative block diagram of a security module;

FIG. 8 is a simplified and representative block diagram of a secure switch; and

FIG. 9 is a flow chart representing a method of managing a capacity-on-demand system.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term id expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 12, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

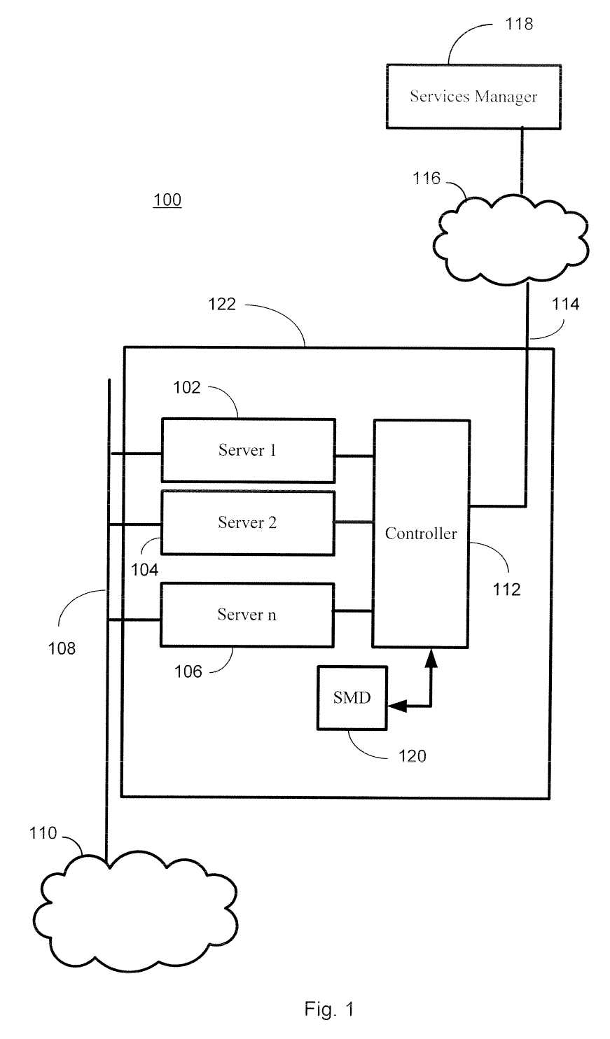

FIG. 1, a block diagram of a system 100 or computing environment supporting capacity-on-demand resource allocation, is discussed and described. A series of servers, including server one 102, server two 104, and server n 106 may be connected to a network 108 and via the network 108 to a wide-area network 110, such as the Internet. The servers 102-106 may support client activity arriving via the wide-area network 110. As mentioned above, the volume of client activity may vary over a wide range as conditions change. At periods of low activity, server one 102 may be able to manage all the client activity. At periods of high activity, all three servers 102-106 may be required. This illustration of scale out is equally valid for a scale up model, where, instead of added servers, additional processing units, memory, etc. may be added when additional capacity is required.

A controller 112, such as a baseboard management controller (BMC), may be used to control and remotely manage the servers 102-106. The controller 112 may be part of a blade server chassis (not depicted) and may be connected directly to each of the servers 102-106. The controller 112 may also be connected to a network 114. The network 114 may be part of a local-area or wide-area network 116 that couples the controller 112 to a services manager 118. The services manager 18 may be used to direct the controller 112 regarding management of the servers 102-106. For example, the controller 112 may reset, power-on, or power-off one or all of the servers 102-106. The controller 112 may also manage software upgrades, perform diagnostics, maintain performance statistics, and monitor quality of service (QoS), as well as other functions.

The controller 112 may not be in a position to securely manage contractual obligations, such as adding servers to increase capacity for a limited period. A security module 120 may be coupled to the controller 112 and may be used on behalf of a provider to securely represent the provider's interests at the server site. In this embodiment, the security module 120 is separate from the controller 112. It is assumed in this configuration that the controller 112 is secure enough to accept and respond to messages from the security module 120. In some embodiments, servers 102, 104, 106, the controller 112, and security module 120 may be packaged as a single server unit 122, such as a blade enclosure and individual blade servers.

In operation, the services manager 118 may determine that an increase in capacity is required for a pre-determined duration. For example, a client who operates a web site may inform a system owner that they expect to need added capacity for a week while the client runs a promotion. The system owner, via the services manager 118 may send cryptographically authenticated message (signed, encrypted, or both) to the controller 112, which may then forward the message to the security module 120. The security module 120 may verify the message and parse the message into a part that designates what servers (or processors/memory in a scale up application) are to be activated. Another part of the message may indicate how long the designated servers are to remain active.

At this point, the services manager 118 has completed its task related to this request for increased capacity. As opposed to other implementations, the security module 120 will manage the shutdown of the added resources at the end of the authorized duration.

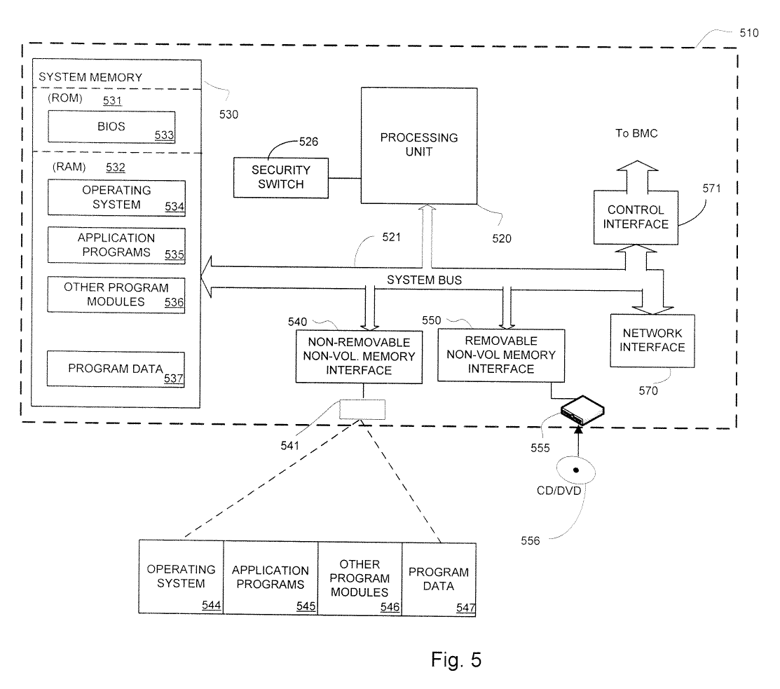

The servers 102-16, controller 112, and security module 120 are discussed in more detail below with respect to FIGS. 5, 6, and 7 respectively.

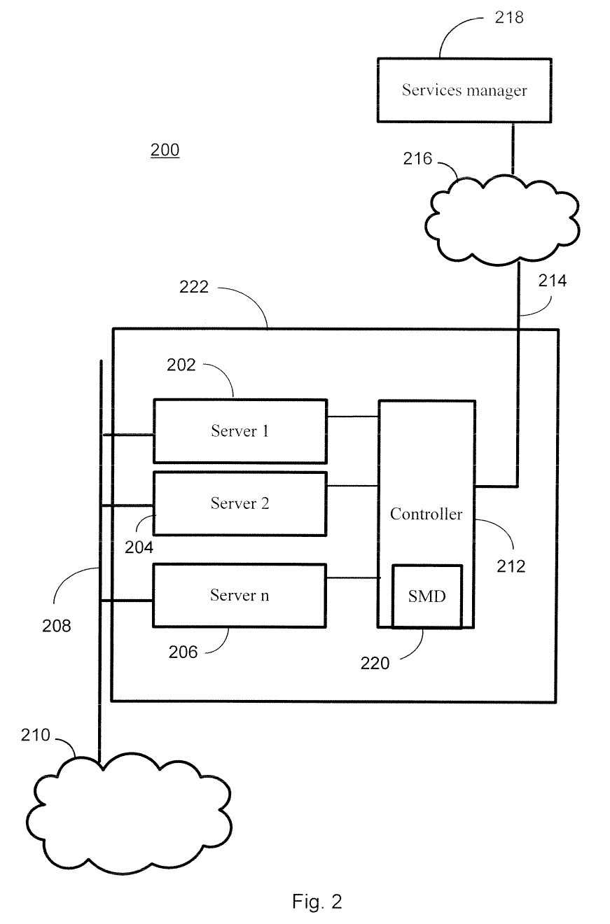

FIG. 2 is a block diagram of another configuration of a system 200 or computing environment supporting capacity-on-demand resource allocation. This configuration is substantially the same as that of FIG. 1 with the exception that the security module 220 is physically implemented on the controller 212.

Server one 202, server two 204, and server three 206 are coupled to network 208 and wide area network 210 on one side and coupled to controller 212 on the other. The controller 212 is coupled to a services manager 218 by one or both of networks 214 and 216. The security module 220 may include secure memory and processing capability separate from a processing and memory capability of the controller 212. When implemented in this fashion, the security module 220 may enjoy a more stable environment that when implemented standalone, as in FIG. 1. Security may be improved because an external connection between the security module 120 and controller 112 of FIG. 1 has been eliminated in FIG. 2, which may improve tamper-resistance. As above, the servers 202, 204, 206, the controller 212/BMC and the security module 220 may be packaged as a single unit, such as a blade enclosure 222.

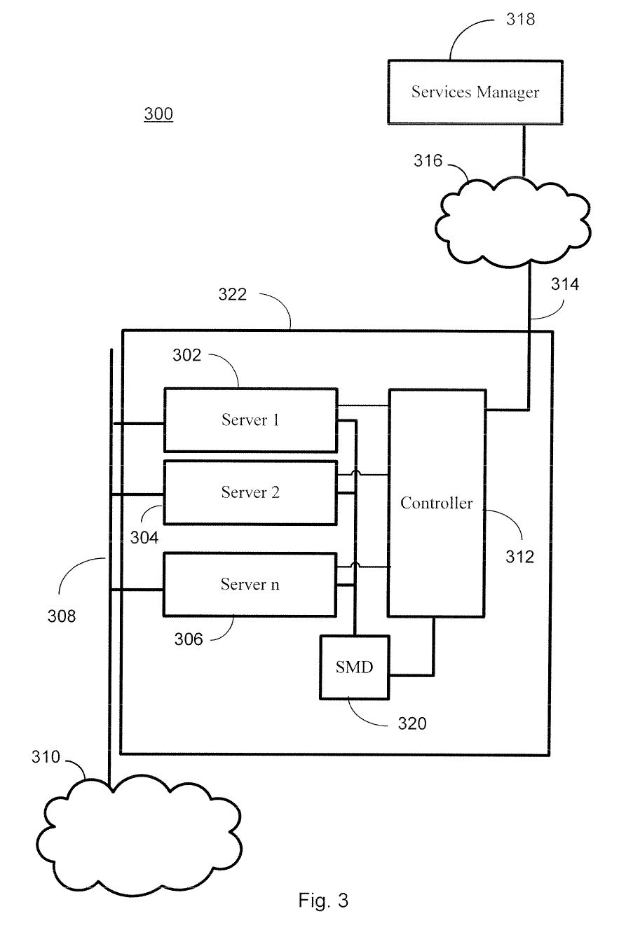

FIG. 3 is a block diagram of yet another configuration of a system 300 or computing environment supporting capacity-on-demand resource allocation. This configuration differs from that of FIGS. 1-2 in that while the security module 320 relies on the controller 312 for communication with the services manager 318, but the security module 320 interacts directly with the servers 302-306 with respect to activation and deactivation.

Server one 302, server two 304, and server three 306 are coupled to network 308 and wide area network 310 on one side and coupled to controller 312 on the other. The controller 312 is coupled to a services manager 318 by one or both of networks 314 and 316. A security module 320 may function to securely manage the availability of servers 302-306 to the network 408. The security module 420 may have a port for packet data communication with the servers 302-306, but may also have separate control lines (not depicted) to each server 302-306 allowing direct management of a server element normally present, for example, a power control, a reset line, or a network interface. The controller 312 may be able to observe the control exercised by the security module 320, but may not be able to override security module control of such resources. As above, the servers 302, 304, 306, the controller 312/BMC and the security module 320 may be packaged as a single unit, such as a blade enclosure 322.

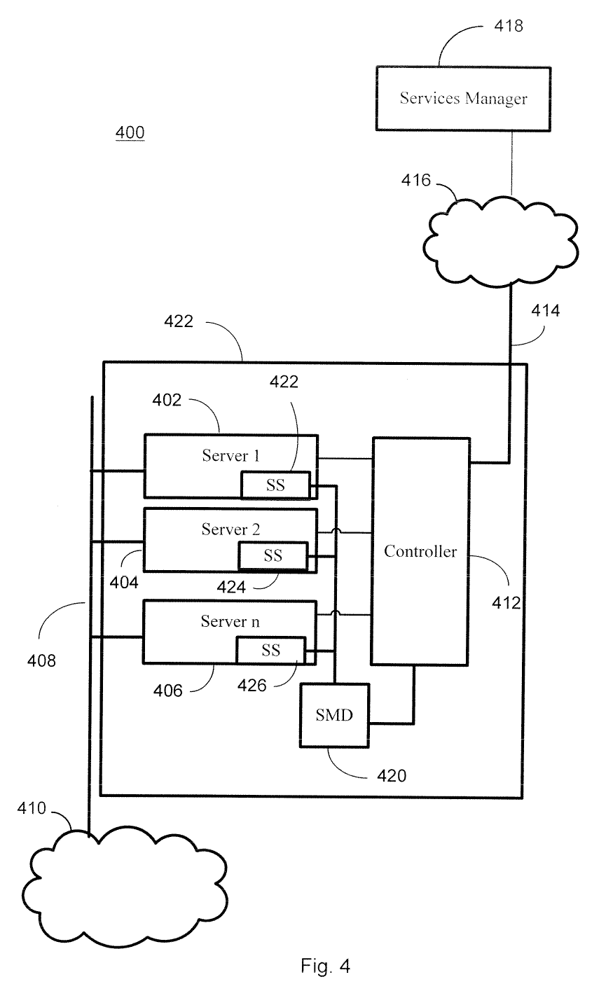

FIG. 4 is a block diagram of still another configuration of a system 400 or computing environment supporting capacity-on-demand resource allocation. This configuration differs from that of FIG. 3 in that the security module 420 communicates with a secure switch 422, or other dedicated component, to control the operation of its associated server.

Server one 402, server two 404, and server three 406 are coupled to network 408 and wide area network 410 on one side and coupled to controller 412 on the other. The controller 412 is coupled to a services manager 418 by one or both of networks 414 and 416. A security module 420 may function to securely manage the availability of server resources 402-406 to the network 408. The security module 420 may have a port for packet data communication with the servers 402-406, but may also have separate control lines (not depicted) to each server 402-406 allowing direct management of a server element, such as secure switch 422 in server one 402, secure switch 424 in server 2 424, and secure switch 426 in server n 406. Each secure switch 422-426 may be able to enable or disable function of one or more components in its associated server, such as data bus, an I/O circuit, or a network interface. The controller 412 may be able to observe the control exercised by the security module 420, but may not be able to override security module 420 control of the secure switches 422-426 or the components to which the secure switches 422-426 are attached. The servers 402, 404, 406, the controller 412/BMC and the security module 420 may be packaged as a single unit, such as a blade enclosure 422

FIG. 5 illustrates a logical view of a computing device in the form of a server 510 that may be used in a capacity-on-demand computing environment or system. For the sake of illustration, the server 510 is used to illustrate the principles of the instant disclosure. Components of the server 510 may include, but are not limited to a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, front side bus, and Hypertransport™ bus, a variable width bus using a packet data protocol.

A secure switch 526 may be incorporated into the server 510 to selectively activate a resource in the server 510. As illustrated, the secure switch 526 is shown coupled to the processing unit 520. As shown, the configuration of the secure switch may be suitable for a scale out application, that is, the entire server 510 resource is either available or not available. In other embodiments, the secure switch 526 may be coupled to an alternate disk drive (not depicted) or a second processor (not depicted). In such a configuration, the secure switch 526 may support a scale up application, that is, adding more processing capability to a server already in service.

Server 510 typically includes a variety of computer readable media. Computer readable media can be any available media that can be accessed by server 510 and includes both volatile and nonvolatile media, removable and non-removable media. By way of example, and not limitation, computer readable media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by server 510.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within server 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536, and program data 537.

The server 510 may also include other removable/non-removable, volatile/nonvolatile computer storage media. By way of example only, FIG. 5 illustrates a hard disk drive 540 that reads from or writes to non-removable, nonvolatile magnetic media and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media discussed above and illustrated in FIG. 5, provide storage of computer readable instructions, data structures, program modules and other data for the server 510. In FIG. 5, for example, hard disk drive 541 is illustrated as storing operating system 544, application programs 545, other program modules 546, and program data 547. Note that these components can either be the same as or different from operating system 534, application programs 535, other program modules 536, and program data 537. Operating system 544, application programs 545, other program modules 546, and program data 547 are given different numbers here to illustrate that, at a minimum, they are different copies.

The server 510 may operate in a networked environment using logical connections to one or more remote computers (not depicted) over a network interface 570, such as broadband Ethernet connection or other known network.

The server 510 may have a control interface 571. The control interface 571 may couple to a baseboard management controller (BMC). Commands may be received through the BMC as if the commands were entered by an administrator at a management console. That is, power on/off, system reset, software maintenance, etc. may all be performed via the control interface 571. The connection between the server 510 and the BMC, e.g. controller 112 of FIG. 1, may use a separate bus or network minimize tampering, or the BMC may share a network, such as an Ethernet connection, with the network interface 570.

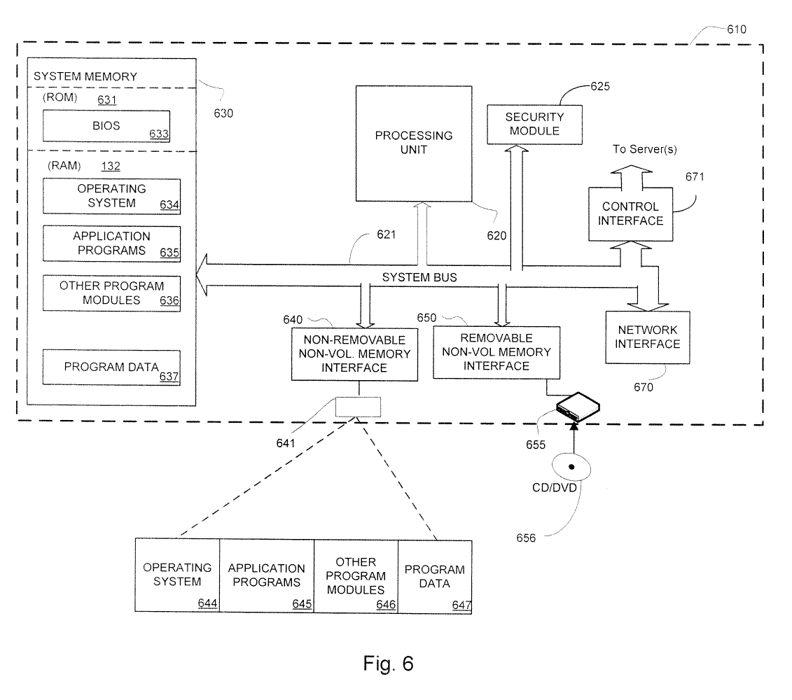

FIG. 6 illustrates a logical view of a computing device in the form of a baseboard management controller (BMC) 610 that may be used in a capacity-on-demand computing environment or system. For the sake of illustration, the BMC 610 is used to illustrate the principles of the instant disclosure. Components of the BMC 610 may include, but are not limited to a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, front side bus, and Hypertransport™ bus, a variable width bus using a packet data protocol.

The BMC 610 may include a security module 625 (SMD). The SMD 625 may be enabled to perform security monitoring, usage management by time or by subscription, and policy enforcement related to terms and conditions associated with paid use of a resource, such as a server 510. The security module 625 may be embodied in the BMC, as shown in FIG. 2. The security module 625 may be in the processing unit 620, may be a standalone component within the BMC 610, or may be a hybrid module in the BMC. The security module may also exist as a separate component outside the BMC 610 as shown in FIGS. 1, 3 and 4.

The BMC 610 typically includes a variety of computer readable media. Computer readable media can be any available media that can be accessed by BMC 610 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by BMC 610.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within BMC 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The BMC 610 may also include other removable/non-removable, volatile/nonvolatile computer storage media. By way of example only, FIG. 6 illustrates a hard disk drive 640 that reads from or writes to non-removable, nonvolatile magnetic media and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the BMC 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies.

The BMC 610 may operate in a networked environment using logical connections to one or more remote computers (not depicted) over a network interface 670, such as broadband Ethernet connection or other known network, as depicted in FIG. 1 by connection 114.

The BMC 610 may have a control interface 671. The control interface 671 may couple to a one or more servers, such as server 510 of FIG. 5. The interface may support command and control of the one or more servers. That is, the interface may support power on/off, system reset, software maintenance, etc. The connection between the BMC 610 and a corresponding server interface, such as interface 571 of FIG. 5, may use a separate bus or network minimize tampering, or the BMC may share a network, such as an Ethernet connection, with the network interface 670.

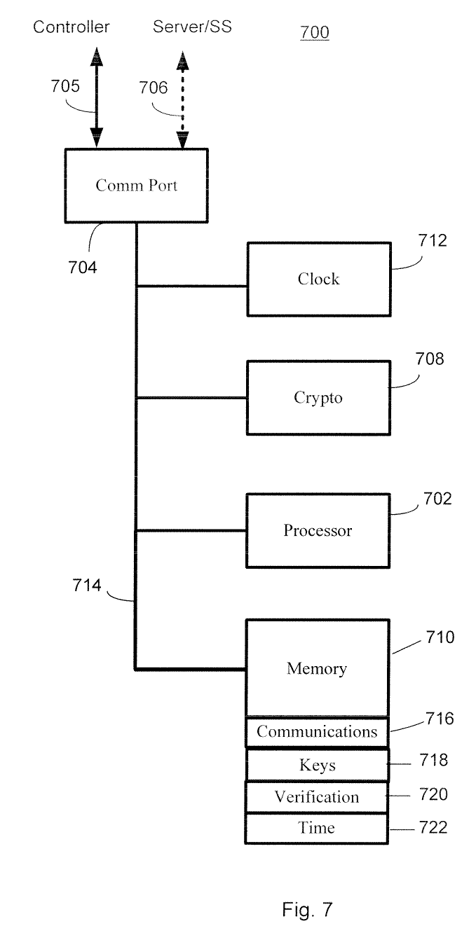

FIG. 7, a simplified and representative block diagram of a security module 700, similar to the security module 420 of FIG. 4, is discussed and described. The security module 700 may include a processor 702, a communication port 704, a secure memory 710, a cryptographic function 708 and a clock or timer 712. The processor 702 may be a core processor implemented in a custom or semi-custom design, or may be part of a single-chip computer, or may be one component in a multi-chip module (MCM). Communication port 704 may support more than one communication protocol, for example as depicted in FIG. 7, connection 705 may support communication with a controller, such as controller 412 of FIG. 4. Communication port 704 may also support direct communication with a secure switch 422 of FIG. 4 or a system component (not depicted) in a server being controlled by the security module 700, as described above. The connection 705 may be a packet interface, such as TCP/IP but other interfaces are possible. The connection 706 may be a packet interface, or may be a protocol with a different overhead structure, such as a serial peripheral interface (SPI) protocol.

The secure memory 710 may include key memory 718 storing a device master key and generated secure switch keys for each secure switch 422-426 associated with the security module 400. The memory may also store communications modules supporting protocols used by the communication port 704. Keys 718 and verification algorithms 720 may be stored in the memory 710 and used in conjunction with the cryptographic function 708. The time memory 722 may be used to store the duration or end-date/time for de-activating a resource, such as a server of the group of servers 402-406 of FIG. 4.

The cryptographic function 708 may be as simple as a random number generator and a block cipher function for use in hashing or message authentication using a MAC algorithm. Alternatively, the cryptographic function 708 may incorporate a smart chip or similar device with full cryptographic capability including public key algorithms, and communicate with the processor 702 using an ISO 7816 interface.

The clock or timer 712 may be used to determine duration periods during which an identified resource may be activated. The clock or timer 712 may also be used to initiate verification messages between the security module 700 and an associated controller 412, secure switches 422-426, a services manager 418 or all of these.

To illustrate operation, the embodiment of FIG. 4 is referred to. The security module 700 is not limited to the embodiment of FIG. 4, but is used for illustration. In operation, the security module 700 may receive a request to add capacity via the controller 412, for example, a baseboard management controller, received from the services manager 418 or other provisioning server. In operation, a services manager or other provisioning server may send an activation signal or provisioning license to the controller 412. If the controller 412 is not capable of processing the activation signal, i.e. does not have an embedded security module 420, then the controller 412 may forward the activation signal or provisioning license to a separate security module 420 or a security module in one or more of servers 402, 404, 406. The activation signal or provisioning license may be signed, encrypted, or both. When the security module 700 has verified the activation signal, it may be parsed into components including a resource identifier and a duration for activation, or alternatively, an expiration date for deactivation. In one embodiment, the activation signal may also include a start time for activation, when the need for additional resources is not immediate.

The security module 700 may then immediately, or at the designated time when deferred, signal the appropriate device to activate a resource. As discussed in the various embodiments, the appropriate device may be the controller 412, a component of a server, or a secure switch 422-426. At the end of the duration, timeout period, or when explicitly instructed, the security module 700 may signal the appropriate device to deactivate the previously started resource, or resources.

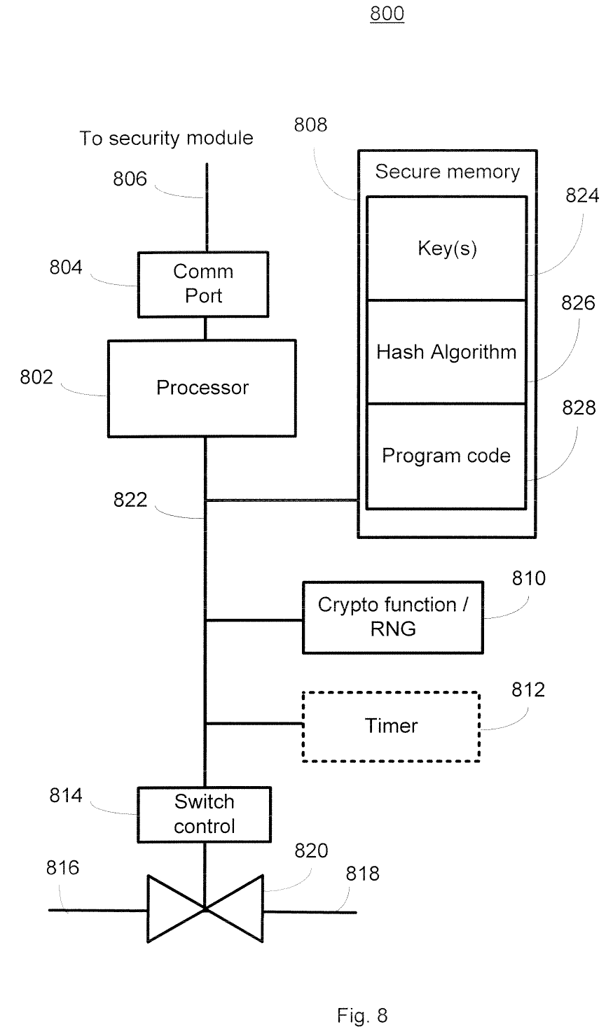

FIG. 8 is a simplified and exemplary block diagram of a security agent, also known as a secure switch 800. A processor 802 may execute programs and control communications with a security module, such as security module 700 of FIG. 7. A communications port 804 may manage communication protocol over interface 806, such as a serial peripheral interface (SPI) or a packet bust. The secure switch 800 may also include a secure memory 808, a cryptographic function 810, an optional timer 812, a switch control 814, and a switch 820 with an input coupling 816 and an output coupling 818.

The processor 802 may be a microprocessor with a standard or reduced instruction set but may also be an application specific integrated circuit (ASIC) implementing simple logic or a state machine. The communication port 804 may be a dedicated port, may be a separate ASIC circuit implementing a communication protocol in hardware, or may be controlled by the processor 802.

The secure memory 808 may include both volatile and nonvolatile memory for use in storing persistent data as well as for use by the processor 802 during operation. The secure memory 808 may include keys 824, a hash algorithm 826, and program code 828. The keys 824 may include a local master key accepted from a security module, such as security module 700. The keys 824 may be installed during configuration with the security module, in a process that binds the security module 700 with the security device 800.

The cryptographic function 810 may include a hash function for use instead of or in conjunction with a hash algorithm 826 stored in the secure memory 808. The crypto function 810 may also include a random number generator (RNG) for use in challenge/response communication with the security module 700.

The optional timer 810 may be used to insure periodic communication with the security module 700 or to time an operational duration when not managed by the security module 700.

The switch control 814 may be simple logic to convert a command from the processor 802 to control switch 820, which may be an ordinary analog switch, known in the art. Even though signal lines 816 and 818 have been designated as an input coupling and output coupling respectively, in one embodiment, the signal lines 816 818 are interchangeable. The signal lines may be used to connect an operational signal, such as a power connection, or may be used to disconnect a signal, such as a chip select, in either case, disabling the associated circuit.

After installation, upon startup of the secure switch 800, the switch 820 may be set to a default state, for example, to disable the associated circuit. During operation, the secure switch 800 may be turned off and on when an authenticated command is received from the security module 700. In some cases, the secure switch 800 may be activated for testing and configuration when the security module 700 activates the secure switch 800 responsive to a request from the services manager 418 or the controller 412.

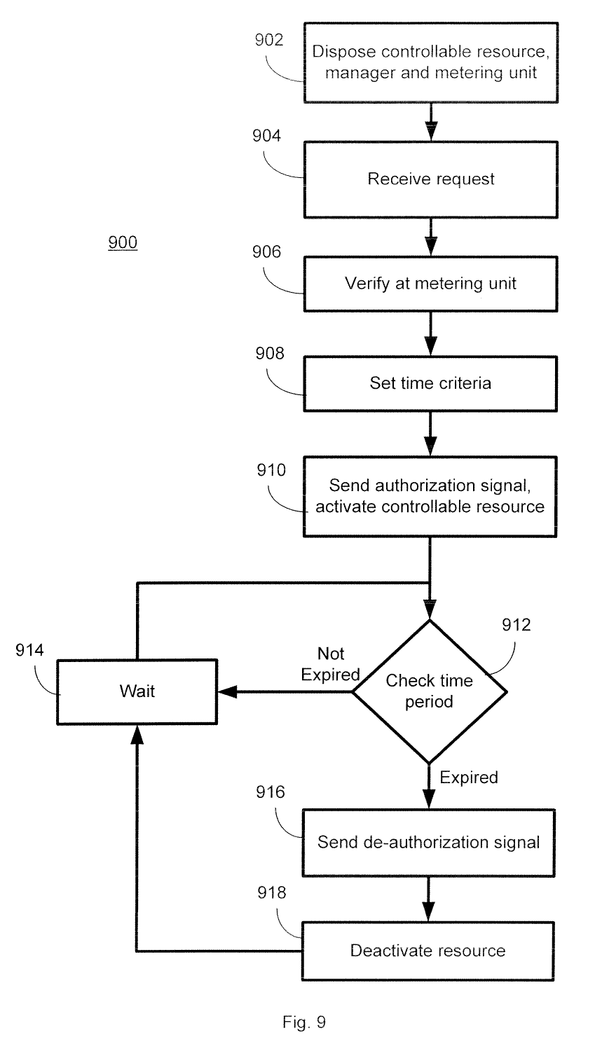

FIG. 9 is a flow chart representing a method 900 of managing a capacity-on-demand system or computing environment 400. At block 902, a controllable resource 402, or a plurality of controllable resources 402-406, may be disposed in the computing environment 400, along with a controller 412, and a security module 420. At block 904, a request may be received at the controller 412. The request may be for activating the controllable resource 402-406 or may be for de-activating the controllable resource 402-406. The request may be passed to the security module 420 for cryptographic verification at block 906. In one embodiment, the request is in the clear and signed, in another embodiment, the request is encrypted and, optionally, signed. The request may contain an identifier of the controllable resource 402 and may also include a duration for activation of the identified resource or an expiration date/time.

In some embodiments, the controller 412 may deactivate the security module 420 when no servers are active. In that case, or in the case when each server contains a security module, the controller 412 may store requests destined for the security module. The controller may activate the security module in question and then forward the request to the security module.

At block 908, the security module 420 may set a timer or clock 712 to the expiration date/time or duration specified in the request. At block 910, an authorization signal may be sent to the controller 412, causing the controller 412 to activate the identified controllable resource 402. In other embodiments, the activation signal may be sent directly to the controllable resource 402 or to a secure switch 422 in the controllable resource 402. When sending an activation signal to a secure switch 422, the activation signal may be cryptographically authenticated using the keys installed during installation and configuration. The keys of each secure switch 800 may be known only to the security module 700, causing each secure switch to respond only to its security module 700. This key exchange process binds each secure switch 800 to its respective security module 700. In other embodiments, to allow for repair and replacement, a common set of keys may be used by a given operating entity or service provider. Any or all of the controllable resources of FIG. 4 are illustrative of controllable devices, the use of controllable resource 402 is simply for convenience of the discussion. When activated, the controllable resource 402 may accept and process traffic from the wide-area network 410, the network 408, or both.

At block 912, the expiration date/time or activation duration may be checked. If the time has not expired, the ‘not expired’ branch from block 912 may be taken to block 914, and after a wait period at block 914, the execution continued at block 912, where the expiration may again be checked. When, at block 912 the expiration date/time has passed, or the activation duration has been met, the ‘expired’ branch from block 912 may be taken to block 916.

At block 916, a de-activation signal may be sent from the security module 420 to the appropriate entity, depending on implementation, in one embodiment, the controller 412, in another embodiment, the controllable resource 402 or a secure switch 422 in the controllable resource 402. Responsive to the de-activation signal, the controllable resource 402 may be removed from service.

Although the foregoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A computing system supporting capacity-on-demand resources comprising:
a plurality of server modules supporting computing tasks, each server module having a computing resource that is selectively operational;
a controller having a first processor, the controller operable to perform system management functions for one or more server modules of the plurality of sever modules;
a secure management unit coupled to the controller for locally managing authorized use of the computing resource of a respective server module of the plurality of server modules, the service management unit comprising:
a cryptographic unit that decodes an activation signal including a designation for an identified server module of the plurality of server module and a time period for authorizing use of the identified server module;
a clock;
a second processor coupled to the cryptographic unit and the clock; and
an enforcement mechanism coupled to the second processor for authorizing the use of the computing resource of the identified server module for the time period, responsive to the activation signal and after qualification of the activation signal by the cryptographic unit.

2. The computing system of claim 1, further comprising a host application for generating and sending the activation signal to the service management unit.

3. The computing system of claim 1, wherein the controller is one of a plurality of controllers, each controller managing a corresponding one of the plurality of server modules.

4. The computing system of claim 3, wherein the activation signal comprises a provisioning license.

5. The computing system of claim 1, wherein the enforcement mechanism selectively de-activates the computing resource of the identified server module responsive an expiration of the time period.

6. The computing system of claim 1, wherein the service management unit communicates through the controller for receiving the activation signal and for selectively activating the computing resource of the identified server module.

7. The computing system of claim 1, further comprising a secure switch coupled to the computing resource of the identified server module, the secure switch operable to enable operation of the computing resource responsive to a signal from the enforcement mechanism.

8. A method of controlling selective activation of resources in a computing environment for a predetermined duration of time:
disposing a controllable resource in the computing environment;
disposing a controller in the computing environment, the controller operable to activate and deactivate the controllable resource;
disposing an security module in the computing environment, the security module being tamper-resistant;
receiving a request for activating the controllable resource, the request specifying the controllable resource and a duration for activating the controllable resource;
forwarding the request to the security module;
sending an activation signal from the security module;
activating the controllable resource via the security module; and
sending a deactivation signal from the security module to the controller at the expiration of the duration for activating the resource.

9. The method of claim 8, further comprising disposing a security agent in the controllable resource operable to enable and disable operation of the controllable resource, wherein sending the activation signal from the security module comprises sending a cryptographically authenticated activation signal to the security agent from the security module.

10. The method of claim 9, wherein sending the activation signal from the security module comprises sending a cryptographically authenticated activation signal from the security module.

11. The method of claim 8, wherein sending the activation signal from the security module comprises sending the activation signal to the controller instructing the controller to activate the controllable resource.

12. The method of claim 8, further comprising performing a cryptographic authentication of the request at the security module.

13. The method of claim 12, further comprising:
parsing the request at the security module into a resource identifier of the controllable resource and the duration when the cryptographic authentication succeeds; and
activating a timing circuit at the security module with an expiration time set corresponding to the duration.

14. The method of claim 8, wherein the controllable resource is a server.

15. The method of claim 8, wherein the controller is a baseboard management controller (BMC).

16. The method of claim 8, wherein disposing the security module in the computing environment comprises disposing the security module in the controller.

17. The method of claim 8, further comprising:
storing the request at the controller when the security module is inactive, and wherein forwarding the request to the security module comprises forwarding the request to the security module when the controller determines the security module is accepting messages.

18. The method of claim 17, further comprising activating the security module when the controller determines a request for the security module is stored at the manager.

19. A method of locally managing server resources in a system with a plurality of servers controlled, a baseboard management controller for managing each of the plurality of servers, and a security module adapted to securely decode provisioning messages and coupled to the baseboard management controller, the method comprising:
receiving a provisioning message comprising an identifier corresponding a selected server of the plurality of servers and a duration corresponding to an operation period for the selected server;
cryptographically authenticating the provisioning message at the security module;
sending an activate message from the security module to the baseboard management controller to activate the selected server;
maintaining a time measurement at the security module corresponding to the operation period specified in the provisioning message;
sending a deactivate message from the security module to the baseboard management controller to deactivate the selected server at the end of the operation period.

20. The method of claim 19, further comprising:
disposing at least one secure switch in each of the plurality of servers, each secure switch bound to the security module and operable to enable operation of its respective server of the plurality of servers;
sending the activate message from the security module to a selected secure switch in the selected server via the baseboard management controller to enable the selected server; and
sending the deactivate message from the security module to the selected secure switch via the baseboard management controller to disable the selected server when the operation period measured at the security module expires.
